(19) United States
(12) Patent Application Publication
(10) Pub. No.: US 2016/0171490 A1
(43) Pub. Date: Jun. 16, 2016

(54) SEARCHABLE TRANSACTION BASED COMMERCE DATABASE

(71) Applicant: International Business Machines Corporation, Armonk, NY (US)

(72) Inventors: Jaspreet Singh, Rohini (IN); Thomas Stober, Herrenberg (DE)

(21) Appl. No.: 14/568,860

(22) Filed: Dec. 12, 2014

(51) Int. Cl. G06Q 20/38

(52) U.S. Cl. CPC G06Q 20/389

(57) ABSTRACT

In an approach for creating a transaction based searchable resource, a computer receives a transaction record and a unique identification. The computer identifies commodity data associated with the received transaction receipt, wherein the identified commodity data includes one or more commodities with transaction dates and one or more of the following: product descriptions and service descriptions. The computer determines an account within a repository that corresponds to the received unique identification. The computer stores the identified commodity data within the determined account in the repository.

### BACKGROUND OF THE INVENTION

The present invention relates generally to the field of electronic commerce, and more particularly to creating an online transaction based storefront resource.

Commerce refers to the overall system of an economy including legal, economic, political, social, cultural, and technological systems that constitute an environment for business operation in a country. Therefore, commerce represents business components associated with activities, functions, and institutions facilitating the engagement of consumers and sellers in an exchange (e.g., transference of products and services for a form of currency). As technology develops and becomes more readily available, electronic commerce (e.g., trading products or services using computer networks) has become a growing segment of commerce. Traditional brick and mortar storefronts (e.g., companies with a physical presence offering face to face experiences) may be augmented or in some cases replaced by electronic storefronts (e.g., companies which host a website advertising products and services for which consumer transactions are generated online).

Online shopping has become increasingly popular on the World Wide Web due to thousands of merchant web sites offering products and services for sale through electronic storefronts (e.g., websites). Electronic storefronts utilize software to provide a convenient means for a consumer to acquire products and services by allowing consumers to browse, select, and purchase items through the presented webpages. For example, most electronic storefronts include available products, contact information, online ordering capabilities, inventory management, and online payment systems, which may be accessed by a consumer without physically visiting a traditional brick and mortar storefront. Inventory management refers to a system that encompasses all aspects of managing a company's inventories; purchasing, shipping, receiving, tracking, warehousing and storage, turnover, and reordering. As consumers make purchases, integrated inventory management systems may provide up-to-date inventory conditions and levels may be available to both the business and future consumers. Additionally, businesses with an online presence may benefit from analysis tools and online services available based on the shopping habits and inventory of a business.

### SUMMARY

Aspects of the present invention disclose a method, computer program product, and system for creating a transaction based searchable resource. The method includes one or more computer processors receiving a transaction record and a unique identification. The method further includes one or more computer processors identifying commodity data associated with the received transaction receipt, wherein the identified commodity data includes one or more commodities with transaction dates and one or more of the following: product descriptions and service descriptions. The method further includes one or more computer processors determining an account within a repository that corresponds to the received unique identification. The method further includes one or more computer processors storing the identified commodity data within the determined account in the repository.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a transaction acquisition application on a client device within the data processing environment of FIG. 1, the application acquires purchased product and service information, in accordance with an embodiment of the present invention;

FIG. 3 is a flowchart depicting operational steps of a product and service generator program on a server within the data processing environment of FIG. 1, the program creates a searchable directory of purchased products and services, in accordance with an embodiment of the present invention;

FIG. 4 is a flowchart depicting operational steps of a product and service search program on a server within the data processing environment of FIG. 1, the program searches the created product and service directory and allows consumer feedback, in accordance with an embodiment of the present invention; and

FIG. 5 is a block diagram of components of the server executing the transaction product and service program, in accordance with an embodiment of the present invention.

### DETAILED DESCRIPTION

Consumers familiar with an area may know which businesses provide certain types of products and services, such as grocery stores, hospitals, gas stations, and clothing stores as they are commonly utilized. However, when looking for a specific product or service, one infrequently used, or when one is not familiar with an area, consumers may perform a search of some type to determine businesses that provide the product or service. Businesses that are augmented by electronic storefronts, thus having an online presence, allow consumers to determine whether businesses carry or provide products and services prior to visiting or contacting the business. Some businesses, however, such as small, locally owned, and operated businesses, may suffer from economic and/or environmental issues which impact the ability for the business to have an online presence.

As recognized by embodiments of this invention, businesses without an online presence may be overlooked by consumers as Internet searches may not identify the business within search results, or the search results may not provide enough information about what products and services are available. Embodiments of this invention allow for the creation of an online presence for a business without creating an electronic storefront or providing a detailed inventory, which may be time consuming and costly. Additionally, as also recognized by embodiments of this invention, businesses without an online presence are unable to take advantage of some analysis tools that may facilitate in business growth. Embodiments of this invention provide a means for a business to acquire information based on transactions, which may be analyzed.

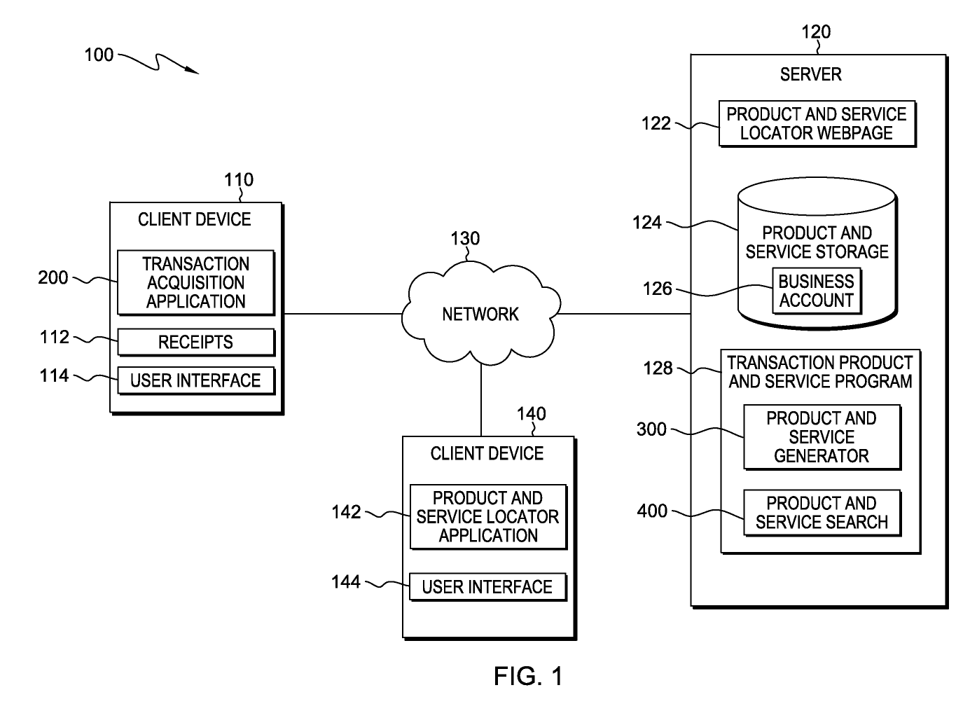

The present invention will now be described in detail with reference to the Figures. FIG. 1 is a functional block diagram illustrating a distributed data processing environment, generally designated 100, in accordance with one embodiment of the present invention. FIG. 1 provides only an illustration of one embodiment and does not imply any limitations with regard to the environments in which different embodiments may be implemented.

In the depicted embodiment, distributed data processing environment 100 includes client device 110, client device 140, and server 120 interconnected over network 130. Distributed data processing environment 100 may include additional computing devices, mobile computing devices, servers, computers, storage devices, or other devices not shown.

Client device 110 and client device 140 may be an electronic device or computing system capable of executing machine readable program instructions and receiving and sending data. In various embodiments, client device 110 and client device 140 may be a laptop computer, a tablet computer, a netbook computer, a personal computer (PC), a desktop computer, a personal digital assistant (PDA), a smart phone, or any programmable electronic device capable of communicating with another computing device via network 130. In other embodiments, client device 110 and client device 140 may represent a computing system utilizing multiple computers and components acting collectively to perform a task when accessed through network 130 as is common in data centers and with cloud computing applications. In the depicted embodiment, client device 110 is utilized by a business to perform transactions and other activities related to operating a business (e.g., cash register, credit card transactions, ordering, etc.), whereas client device 140 is utilized by a consumer to locate products and services provided by a business and to provide consumer feedback. Client device 110 includes receipts 112, user interface 114, and transaction acquisition application 200. Client device 140 includes product and service locator application 142 and user interface 144.

Receipts 112 are records of transactions involving a commodity (e.g., documented acknowledgment of the purchase of products and/or services) between a business and a consumer as created by a mechanical or electronic device. A commodity may be a product (e.g. tangible, physical item) or a service (e.g., non-physical perceived item) that satisfies human needs and provides a utility. Receipts 112 may include relevant information (e.g., commodity data) about a consumer purchase. Commodity data may include relevant information, such as product and service descriptions, quantity purchased, purchase price, business name, business location, date purchased, etc. In one embodiment, receipts 112 are electronic receipts (e.g., receipt from a computer payment program, electronic handwritten receipt from a touchscreen, credit card transaction, etc.). In another embodiment, receipts 112 may be a paper receipt (e.g., handwritten, cash register receipt). Receipts 112 are processed by transaction acquisition system 200 for utilization by transaction product and service program 128, and more specifically product and service generator 300. In the depicted embodiment, receipts 112 resides on client device 110. In other embodiments, receipts 112 may reside on other devices, such as server 120, provided that receipts 112 are accessible to transaction acquisition program 200.

User interface 114 is a program that provides an interface between a user of client device 110 and a plurality of applications, including transaction acquisition application 200, which resides on client device 110 and/or may be accessed over network 130. A user of client device 110 can utilize user interface 114 to perform transactions resulting in receipts 112. Additionally, user interface 114 may send receipts 112 through transaction acquisition application 200 to transaction product and service program 128 for utilization by product and service generator 300. User interface 114 may also display received information from transaction acquisition application 200 and transaction product and service program 128. User interface 144 is a program that provides an interface between a user of client device 140 and a plurality of applications, including product and service locator application 142, which resides on client device 140 and/or may be accessed over network 130. A user of client device 140 can utilize user interface 144 to perform search requests and enter consumer feedback through product and service locator application 142 and product and service locator webpage 122. User interface 144 may display received information from product and service locator application 142 and product and service locator webpage 122. User interfaces, such as user interface 114 and user interface 144, refer to the information (e.g., graphic, text, sound) that a program presents to a user and the control sequences the user employs to control and interact with the program. A variety of types of user interfaces exist. In one embodiment, user interface 114 and user interface 144 are graphical user interfaces. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. The actions in GUIs are often performed through direct manipulation of the graphical elements.

Server 120 may be any electronic device or computing system capable of processing program instructions and receiving and sending data. In some embodiments, server 120 may be a laptop computer, a tablet computer, a netbook computer, a PC, a desktop computer, a PDA, a smart phone, or any programmable device capable of communication with client devices 110 and 140 over network 130. In other embodiments, server 120 may represent a server computing system utilizing multiple computers as a server system, such as in a cloud computing environment. Server 120 includes product and service locator webpage 122, product and service storage 124, and transaction product and service program 128, which includes product and service generator 300 and product service search 400.

Product and service locator webpage 122 is a webpage providing an interface between product and service locator application 142 and transaction product and service program 128. A webpage is a web document that is suitable for the World Wide Web and the web browser. A web browser displays a webpage through a user interface, such as user interface 114 and user interface 144 through a visual display (e.g., monitor, smart phone, etc.). Product and service locator webpage 122 receives requests for information from product and service locator application 142 and sends the requests to transaction product and service program 128 for processing. Product and service locator webpage 122 receives corresponding responses to the requests from transaction product and service program 128 and sends the corresponding responses to product and service locator application 142. In the depicted embodiment, product and service locator webpage 122 is located on server 120. In another embodiment, product and service locator webpage 122 may reside on another server or another computing device connected over network 130, provided product and service locator webpage 122 is accessible to product and service locator application 142 and transaction product and service program 128.

Product and service storage 124 is a repository for transaction product and service program 128 to store information generated though product and service generator 300 and product and service search 400. Product and service storage 124 includes information based on processed consumer transactions and consumer feedback. Product and service storage 124 includes business account 126. Product and service storage 124 can be implemented with any type of storage device that is capable of storing data that may be accessed and utilized by transaction product and service program 128. In some embodiments, product and service storage 124 may also be accessible by client device 110 through a data analysis tool (not currently shown). In the depicted embodiment, product and service storage 124 resides on server 120. In other embodiments, product and service storage 124 may reside on another server or another computing device connected over network 130, provided that product and service storage 124 is accessible to transaction product and service program 128.

Business account 126 is a location within product and service storage 124 for storing information (e.g., transactions, files, database entries, feedback, statistical information, etc.) specific to a business. Business account 126 is representative of a plurality of unique accounts associated with a plurality of businesses utilizing transaction product and service program 128. When business account 126 is created, a unique business identification is assigned. In one embodiment, the unique business identification may be generated for business account 126 (e.g., program assigns a unique, name, number, combination of letters and numbers, etc.). In some other embodiment, the unique business identification may be selected for business account 126 by the user (e.g., user creates a business identification or selects a business identification from a list of generated potential business identifications). In an example embodiment, when business account 126 is created, at a minimum, the business name, address, and contact phone number is included. Additional supplemental information may also be included in business account 126, such as hours of operation, type of business, synopsis of products and services provided, areas serviced, and payment methods etc., enhancing the information which may be provided to a consumer. Business account 126 is initially created by a business to upload transaction information through transaction acquisition application 200. Business account 126 may be updated by additional transactions and consumer feedback. In the depicted embodiment, business account 126 is included in product and service storage 124. In other embodiments, business account 126 may reside on another server, another storage device, or another computing device connected over network 130, provided that business account 126 is accessible to transaction product and service program 128.

Transaction product and service program 128 is an overall program encompassing software to process consumer transactions, creating a searchable format and the means to search and provide feedback thus creating a more robust business and consumer resource of products and services provided by a business. In the depicted embodiment, transaction product and service program 128 includes product and service generator 300 and product and service search 400. In the depicted embodiment, transaction product and service program 128 resides on server 120. In other embodiments, transaction product and service program 128 may reside on other devices, such as another server or computer connected over network 130 provided that transaction product and service program 128 is accessible to transaction acquisition application 200 and product and service locator webpage 122.

Network 130 may be a local area network (LAN), a wide area network (WAN) such as the Internet, a wireless local area network (WLAN), any combination thereof, or any combination of connections and protocols that will support communications between client device 110, other computing devices, and servers (not shown), in accordance with embodiments of the inventions. Network 130 may include wired, wireless, or fiber optic connections.

Product and service locator application 142 is a set of one or more programs designed to carry out operations including the capability to send and receive information to and from product and service locator webpage 122. Product and service locator application 142 is accessed by user interface 144 to request information regarding products and services available to the user of client device 140 based on selected searchable criteria (e.g., product, service, location, etc.) incorporated in product and service locator webpage 122. Product and service locator application 142 may then display received information from product and service locator webpage 122 in response to the processed search criteria by transaction product and service program 128. In the depicted embodiment, product and service locator application 142 resides on client device 140. In other embodiments, product and service locator application 142 may reside on other devices, such as client device 110 and server 120, provided product and service locator application 142 is accessible to user interface 144 and has access to product and service locator webpage 122.

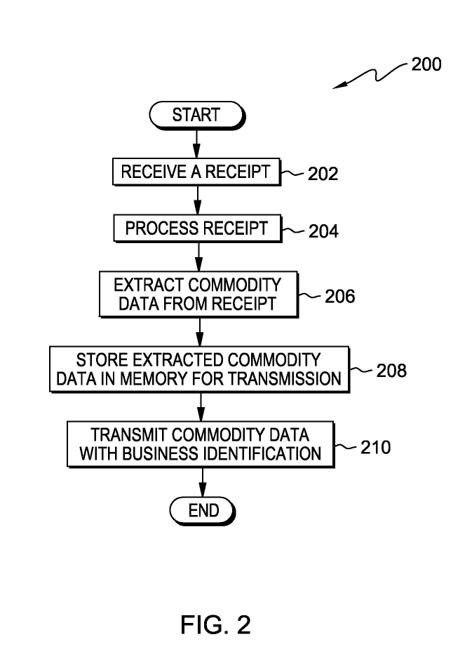

Transaction acquisition application 200 is a set of one of more programs associated with processing consumer transactions to create the raw data for later use by product and service generator 300. Transaction acquisition application 200 performs operations related to processing receipts 112 in response to a transaction. Additionally, transaction acquisition application 200 transmits the processed commodity data from receipts 112 to transaction product and service program 128 (more specifically to product and service generator 300). In the depicted embodiment, transaction acquisition application 200 resides on client device 110. In other embodiments, transaction acquisition application 200 may reside on other devices, such as server 120, provided that transaction acquisition application 200 is accessible to user interface 114 and has access to transaction product and service program 128. Transaction acquisition application 200 is discussed in greater detail in FIG. 2.

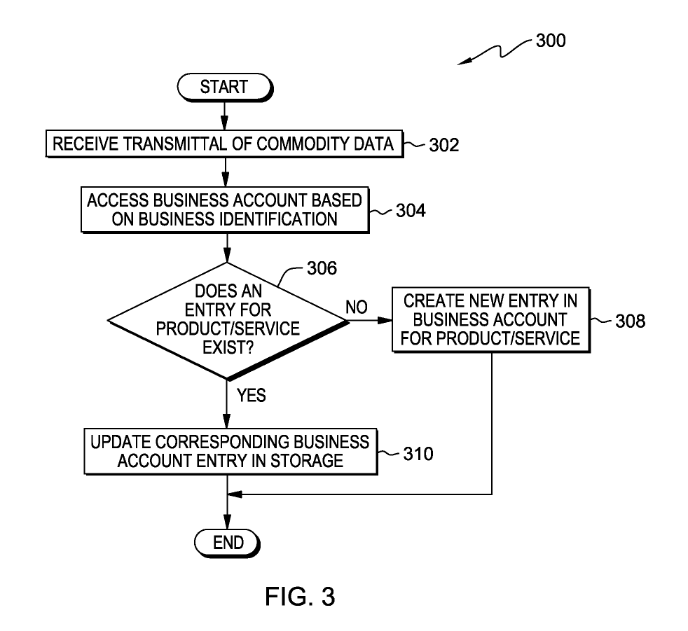

Product and service generator 300 is a set of one of more programs designed to carry out operations related to creating a searchable format (e.g., directory, catalog, database, etc.) of available product and services offered by a business to a consumer. Product and service generator 300 receives information from transaction acquisition application 200 and stores processed commodity data in product and service storage 124. In the depicted embodiment, product and service generator 300 resides on server 120. In other embodiments, product and service generator 300 may reside on other devices, such as client device 110, provided that product and service generator 300 is accessible to transaction acquisition application 200 and product and has access to product and service storage 124. Product and service generator 300 is described in more detail in FIG. 3.

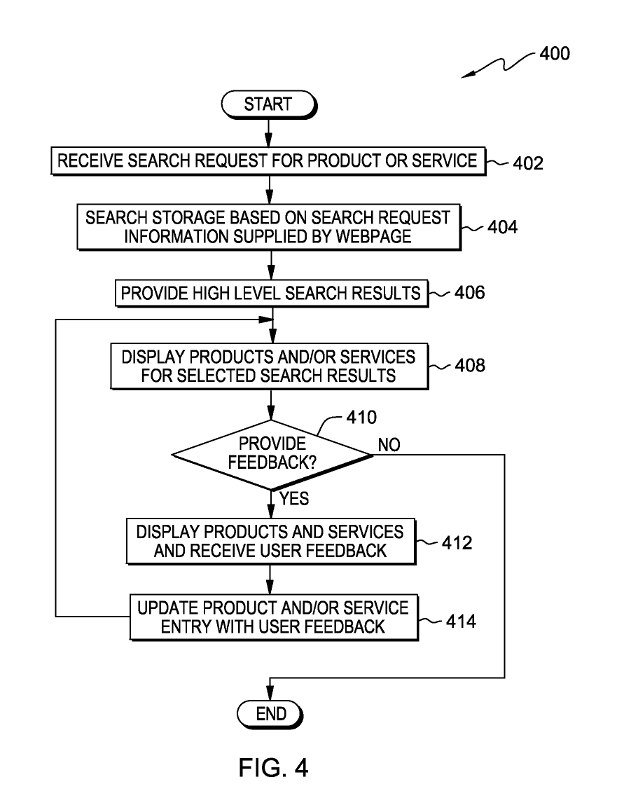

Product and service search 400 is a set of one or more programs designed to carry out operations related to searching the created format of available product and services offered by a business to a consumer. In addition, product and service search 400 allows for the updating of the available products and services through customer feedback. In the depicted embodiment, product and service search 400 resides on server 120. In other embodiments, product and service search 400 may reside on other devices, such as client device 110, provided that product and service search 400 is accessible to product and service locator webpage 122 and has access to product and service storage 124. Product and service search 400 is described in more detail in FIG. 4.

FIG. 2 is a flowchart depicting operational steps of transaction acquisition application 200, an application for acquiring purchased product and service information, in accordance with an embodiment of the present invention.

Prior to utilizing transaction acquisition application 200, business account 126 already exists or is being created for the business. Through the unique business identification associated with business account 126, information regarding transactions occurring at the business are linked to business account 126, which provides information for further processing. Once business account 126 is established, transaction acquisition application 200 may be initiated at any time provided a consumer purchases a product and/or service from a business which results in a transaction producing receipts 112.

In step 202, transaction acquisition application 200 receives receipts 112. In one embodiment, transaction acquisition application 200 receives receipts 112 as an electronic receipt created by an electronic device (e.g., cash register, computer with electronic point of sale software, credit card reader, e-mail, etc.). For example, a product with a barcode is moved past a scanner that processes the barcode and transfers the associated stored commodity data, such as the product description and price to the computer register. At the end of the transaction, receipts 112 may be provided to a consumer and also stored within the computer register. In another embodiment, transaction acquisitions application 200 receives receipts 112 as a scanned image of a manual receipt (e.g., hand-written receipt, manual cash register receipt, paper receipt). For example, an in-home service, such as a chimney cleaning business, may provide a manual receipt of the commodity data indicating the service performed and associated costs on carbon copy paper (e.g., creates simultaneous copies of an original document through the transference of loosely bound dry ink to another paper through applied pressure). Through the use of a scanner, the manual receipt is scanned, thus creating a digital image of receipts 112. In some other embodiment, transaction acquisition application 200 receives receipts 112 after providing user interface 114 with a data entry receipt form noting receipt fields associated with commodity data (e.g., product/service description, date of sale, price, etc.) for a user to input receipts 112 information (e.g., typing through a keyboard, voice entry, etc.).

In step 204, transaction acquisition application 200 processes receipts 112. In one embodiment, transaction acquisition application 200 utilizes handwriting recognition software to process receipts 112, such as when receipts 112 includes hand-written information. Handwriting recognition software interprets the handwritten input from sources, such as paper documents, photographs, scanned images, and touchscreens by extracting the written characters and utilizing a recognition engine to identify the corresponding computer character. Additionally, the handwriting recognition software formats and segments the characters to determine the most plausible words. In another embodiment, transaction acquisition application 200 utilizes optical character recognition to process receipts 112, such as when receipts 112 includes type written or printed machine encoded text. Optical character recognition compares an image to a stored glyph through pattern recognition (e.g., compares images by individual pixels) to determine the correct character. Optical character recognition digitizes printed texts, such as receipts 112 allowing the information to be electronically edited, searched, and stored.

Transaction acquisition application 200 further processes the results from the recognition software analysis of receipts 112 with natural language processing. Natural language processing derives the meaning from human language within textual information. Transaction acquisition application 200 applies natural language processing and at least one set of dictionaries and rules to perform text analytics on receipts 112 to determine the association of information within receipts 112 to recognizable relevant data fields. For example, a receipt includes the words “Quantity,” “Product Description,” and “Price.” By utilizing the definition of the words in the context of a receipt, natural language processing would associate integer values with “Quantity,” text characters with “Product Description,” and decimal number values with “Price.” Therefore, natural language processing would associate the value “1” with “Quantity,” “Flashlight” with “Product Description,” and “9.97” with “Price.” At the completion of processing, transaction acquisition application 200 stores the processed commodity data from receipts 112 with the information assigned to relevant data fields.

In step 206, transaction acquisition application 200 extracts processed commodity data from receipts 112. Transaction acquisition application 200 identifies relevant data fields within the processed commodity data from receipts 112, which may be used to create a directory of purchased products and/or services for a business. At a minimum, transaction acquisition application 200 identifies and then extracts processed commodity data from receipts 112 associated with relevant data fields for a product description and a time and date associated with the transaction. Transaction acquisition application 200 may identify and extract additional information and commodity data from other identified data fields within receipts 112, such as quantity purchased, price, price adjustments, type of transaction (e.g., cash, check, or charge), etc. when present. However, transaction acquisition application 200 does not extract information sensitive to the consumer, such as personal and credit card information (e.g., name, home address, e-mail, credit card number, type of credit card, etc.).

Transaction acquisition application 200 then stores the extracted commodity data within temporary memory for transmission (step 208). In one embodiment, transaction acquisition application 200 may store extracted commodity data as individual temporary files. For example, a new temporary file may be created whenever receipts 112 are processed and the commodity data extracted. Therefore, every transaction would have an associate file that includes the products and services associated with the individual transaction. In another embodiment, transaction acquisition application 200 may store extracted commodity data within a single file, appending new information to the exiting information. For example, transaction acquisition application 200 may store the extracted commodity data in a table format (e.g., spread sheet, rows and columns noting relevant data fields of receipts 112, database entry) and insert a new row within the table and then import the extracted commodity data into the new row. The single file would be capable of storing all transactions which occurred during a time period, thus consolidating the commodity data in one file.

In step 210, transaction acquisition application 200 transmits extracted processed commodity data from receipts 112 and the business identification to product and service generator 300. To identify the correct business account 126, transaction acquisition application 200 first transmits the business identification to product and service generator 300 over network 130. Transaction acquisition application 200 then may transmit one or more files with the extracted processed commodity data from receipts 112 to product and service generator 300 over network 130. In one embodiment, transaction acquisition application 200 may transmit extracted processed commodity data from receipts 112 in response to a transaction resulting in receipts 112. In another embodiment, transaction acquisition application 200 may transmit one or more files of commodity data based on a scheduled interval (e.g., end of the day, set number of transactions, hourly, weekly, etc.). In some other embodiment, transaction acquisition application 200 may transmit one or more files of commodity data at a time initiated by a user through user interface 114. The frequency of the transmission between transaction acquisition application 200 and product and service generator 300 may be altered at any point at the discretion of the business.

FIG. 3 is a flowchart depicting operational steps of product and service generator 300, a program for creating a searchable directory of purchased products and services, in accordance with an embodiment of the present invention.

In step 302, product and service generator 300 receives a transmittal of processed commodity data from receipts 112 (e.g., file, multiple files) and the business identification from transaction acquisition application 200 over network 130. In one embodiment, product and service generator 300 may also receive a form of authentication (e.g., password, security question, retyping of readable text, etc.) for security purposes, ensuring the transmission is valid. Upon receipt of the transmittal from transaction acquisition application 200, product and service generator 300 initiates.

In step 304, product and service generator program 300 accesses business account 126 based on the business identification. Product and service generator 300 identifies the business identification from the transmission message. Product and service generator 300 then utilizes the business identification to identify business account 126 (e.g., the account associated with the business identification) in product and service storage 124 by searching business account 126 for a matching business identification. By utilizing the unique business identification, product and service generator 300 verifies the correct business account 126 is updated with processed commodity data from receipts 112. Product and service generator 300 then accesses the information within business account 126 to perform additional processing and updates with processed commodity data from receipts 112.

In decision 306, product and service generator 300 determines whether an entry for the product and/or service exist within business account 126. Product and service generator 300 accesses the processed commodity data from receipts 112 within the uploaded file. Product and service generator 300 retrieves processed commodity data from receipts 112 as individual separate product and/or service name(s) (e.g., product description, item description, service provided, etc. are separate lines, rows, etc. within the uploaded file(s)). Product and service generator 300 then searches business account 126 for entries matching the product and/or service name(s) individually (e.g., when multiple products and/or services are present, multiple searches may be performed until a determination is made for the multiple identified products and/or services). Product and service generator 300 determines whether an entry exists within business account 126 by performing a text comparison with designated entry fields (e.g., product description, service description, item name, etc.) If product and service generator 300 determines an entry exists for the product and/or service within business account 126 (decision 306, yes branch), then product and service generator 300 updates the corresponding entry in business account 126. If product and service generator 300 determines an entry does not exist for the product and/or service within business account 126 (decision 306, no branch), then product and service generator 300 creates a new entry in business account 126 for the product and/or service.

For example, receipts 112 includes product and service descriptions noted as: “piano tuning” and “treble piano wire.” The processed commodity data from receipts 112 results in the uploaded file (e.g., a received transmittal of information) identifying “piano tuning” and “treble piano wire” as separate items (i.e., the items are placed in two separate individual rows within a spreadsheet). Product and service generator 300 first determines whether an entry exists within business account 126 that also has a product description of “piano tuning” by performing a text comparison with designated entry fields. Product and service generator 300 determines business account 126 includes a description of “piano tuning” and updates the corresponding entry in business account 126. Product and service generator 300 then determines whether the second entry in the spreadsheet, “treble piano wire,” exists in business account 126. Product and service generator 300 determines business account 126 does not include “treble piano wire” and creates a new entry in business account 126 for “treble piano wire.”

In step 308, product and service generator 300 creates a new entry in business account 126 for the product and/or service. Product and service generator 300 populates business account 126 with information from the uploaded file, such as the product and/or service description and date purchased. Product and service generator 300 may additionally include other categories within the entry, such as quantity purchased, price, price adjustment, etc., depending upon the processed commodity data from receipts 112. Product and service generator 300 then stores the new entry within business account 126, thus updating the information (e.g., database, directory, catalog, etc.), which may be accessed later by the business or consumer through product and service locator webpage 122.

In step 310, product and service generator 300 updates the corresponding business account entry for the identified product and/or service in storage. In one embodiment, product and service generator 300 may replace previous information with the latest information (e.g., only the most recent information is maintained). In some other embodiment, product and service generator 300 may update the previous information and calculate other entry values based on current and existing information. For example, a roll of duct tape was purchased in a transaction on Oct. 10, 2014. Product and service generator 300 stores the date as Oct. 10, 2014, the number of items sold associated with the transaction as one, and the total number of items sold to date as one. On Oct. 21, 2014, two additional rolls of the same type of duct tape were purchased. Product and service generator 300 updates the transaction date from October 10^{th} to October 21^{st} and updates the number of items sold associated with the transaction from one to two. However, for the total number of items sold to date, product and service generator 300 calculates the number to be three (e.g., combines the previous entry value with the new value). Product and service generator 300 may additionally calculate other relevant data, such as the time between transactions, price differences, etc. Product and service generator 300 may not update or replace information in a data field where the information is identical. For example, a data field, such as the product description of duct tape, would not need to be updated, additionally, the price data field would not need to be updated if the price did not change.

FIG. 4 is a flowchart depicting operational steps of product and service search program 400, a program for searching the created product and service directory and allowing consumer feedback, in accordance with an embodiment of the present invention.

In step 402, product and service search 400 receives a search request for a product or service through product and service locator webpage 122. A user of client device 140 utilizes user interface 144 to enter and submit search criteria through the interface of product and service locator application 142 with product and service locator webpage 122. Product and service search 400 may receive one or more search criteria (e.g., product and/or service name, store name, search radius, etc.) to potentially provide more relevant search results. For example, a person may be looking for a seamstress service to make alterations on a gown. The user of user interface 144 may enter search terms, such as product and service descriptions of “seamstress, alterations,” the home address of the user, and a 10 mile search radius.

In step 404, product and service search 400 searches product and service storage 124 based on the search request information supplied by product and service locator webpage 122. In one embodiment, product and service search 400 may use natural language processing to determine matches within product and service storage 124. For example, continuing the example of a “seamstress and alterations,” through natural language processing, knowing a seamstress is one who performs changes to a garment through sewing, returned results may include seamstress listings but may also include businesses associated with tailors and sewing services as both are related to the work of a seamstress and alterations. In another embodiment, product and service search 400 searches product and service storage 124 with the search criteria to identify both complete and partial matches (e.g., identifies similar matches to the search criteria). For example, a search may be performed for “hammer,” but product and service search 400 finds multiple entries in product service and storage 124 that include “hammer,” such as “framing hammer,” “claw hammer,” and “steel hammer.” As the additional entries are more specific types of hammers, product and service search 400 identifies the three hammers as part of the product description that matches the search criteria of “hammer.” In addition, product and service search 400 may refine the matches based on other criteria, such as location (e.g., zip code, city name, address, GPS coordinates) and a range (e.g., distance from a specific location). By combining the product description with a location and distance, the search results may become more specific. For example, five stores may sell various types of hammers, one of the five stores is a hundred miles away, 2 stores are between twenty five and fifty miles away, and two other stores are under five miles away. By adding in a maximum range of ten miles from the location, only the last two stores under five miles away would be found to match both search criteria.

In step 406, product and service search 400 provides high-level search results. Product and service search 400 provides basic information regarding the matches determined by the search. Product and service search 400 may provide high-level results for one or more matches. For example, product and service search 400 results provides information regarding what terms from the search were matched and specific store information, such as store hours, location, directions, phone number, etc. Within the high-level search results, product and service search 400 may provide additional selectable options (e.g., hyperlink to another webpage, “+,” “More,” view and/or download a file, etc.) to expand on details associated with the selected high-level search result.

In an exemplary embodiment, product and service search 400 places the high-level search results in an ordered list by the transaction date (e.g., newest to oldest). For example, a search is performed for a hairdryer. Product and service search 400 identifies two different business accounts (e.g., business account 126) with business names of “hair salon” and “convenience store” in product and service storage 124 that include entries for transactions associated with the purchase of a hairdryer. The transaction date associated with “convenience store” indicates the hairdryer was purchased a year ago; whereas, the transaction date associated with “hair salon” indicates the hairdryer was purchased today. Product and service search 400 displays “hair salon” first, as the transaction date is more recent (e.g., recent activity indicates “hair salon” sells the hairdryer and may have additional hairdryers in stock), followed by “convenience store,” as the transaction date is less recent (e.g., lack of recent activity may indicate “convenience store” no longer sells the hairdryer, or the hairdryer may be out of stock).

In another embodiment, product and service search 400 places the search results in an ordered listing as partially determined by the user. For example, product and service search 400 can order the results alphabetically, by distance, rating, best match, date, etc. Alternatively, product and service search 400 may provide results indicating no matches were found and to perform another search. Product and service search 400 continues to display the high-level search results until product and service search 400 receives a selection of a specific business, or the program is closed (e.g., program is ended by closing the webpage).

In step 408, product and service search 400 displays products and/or services for selected search results. From the list of high-level search results provided (step 406), product and service search 400 may receive a selection of a specific high-level search result through user interface 144 via product and service locator webpage 122. Product and service search 400 may then display additional information specific to the selection. In one embodiment, product and service search 400 may navigate to an additional webpage including more specific information regarding products and/or services provided by an individual business. In another embodiment, product and service search 400 may expand the section of the current webpage providing more detailed information. In yet some other embodiment, product and service search 400 may open a new tab or window to display the listing of products and services. Product and service search 400 may include additional functionality, such as the option to provide user feedback for the specified business. Product and service search 400 continues to display specific individual store, product information, and service information until product and service search 400 receives a selection regarding entering feedback, or the program is closed (e.g., program is ended by closing the webpage).

In decision 410, product and service search 400 determines whether feedback is to be provided. In one embodiment, product and service search 400 may display a selection to provide feedback on the returned results. In another embodiment, product and service search 400 may display an option to provide feedback based on categories (e.g., type of service, department, groups of related items, transaction date, etc.). In some other embodiment, product and service search 400 may provide an option to provide feedback on all entries for a business (e.g., the feedback may be used by the business to facilitate the development of an inventory). Product and service search 400 displays one of the aforementioned requests to provide feedback through user interface 144 as selectable icons and/or text (e.g., hyperlink, radio buttons, check box, and push buttons). Product and service search 400 may receive a positive selection from user interface 144 indicating feedback will be provided (e.g., “yes” is selected, selection of the hyperlink to feedback, etc.). Alternatively, product and service search 400 may receive a negative selection from user interface 144 indicating feedback will not be provided (e.g., “no” is selected, application is closed). If product and service search 400 determines feedback is to be provided (decision 410, yes branch), then product and service search 400 displays products and services and receives feedback (step 412). If product and service search 400 determines no feedback is to be provided (decision 410, no branch), then product and service search 400 completes.

In step 412, product and service search 400 displays products and/or services and receives user feedback. Product and service search 400 displays one or more individually selectable products and/or services for selection for feedback. For example, a list of four products are listed for transactions occurring on a specific date. The user of user interface 144 purchased two of the four items. A user may select one or more of the listed items and provide feedback. The user may also exit from feedback at any time either before or after providing feedback on one or more items. Product and service search 400 may include feedback for information useful to another consumer (e.g., product ratings, comments, number of items in store). Product and service search 400 may also include feedback for information useful to the business (e.g., how often item purchased, number of items in stock, customer service rating, pricing versus value).

In step 414, product and service search 400 updates the selected product and/or service with user feedback. Product and service search 400 receives an indication through product and service locator webpage 122 that feedback is completed (e.g., user selects “done,” “finish,” etc.). Product and service search 400 accesses the identified product and/or entry within business account 126. Once product and service search 400 accesses business account 126, product and service search 400 stores the feedback within the product and/or service entry within business account 126. As product and service search 400 receives feedback for the same product and/or service, subsequent searches may provide the composite historical data for the product and/or service which may be viewed by consumers and the business. For example, a lawn service is utilized by five consumers. Three of the consumers provide a rating of five, and two rate the lawn service at 2 and 3 stars and leave a written review indicating a problem with the service. The business owner is able to access the information to make improvements, and a new consumer searching for a lawn service is provided with information to make a decision upon. After updating business account 126, product and service search 400 may display a message indicting the upload was successful prior to returning to display products and/or services for selected search results. Product and service search 400 continues to perform steps 408 through 414 until the user exits the program or does not select to provide feedback. Additionally, at any point, a new search may be initiated by the user removing product and service search 400 from acquiring feedback.

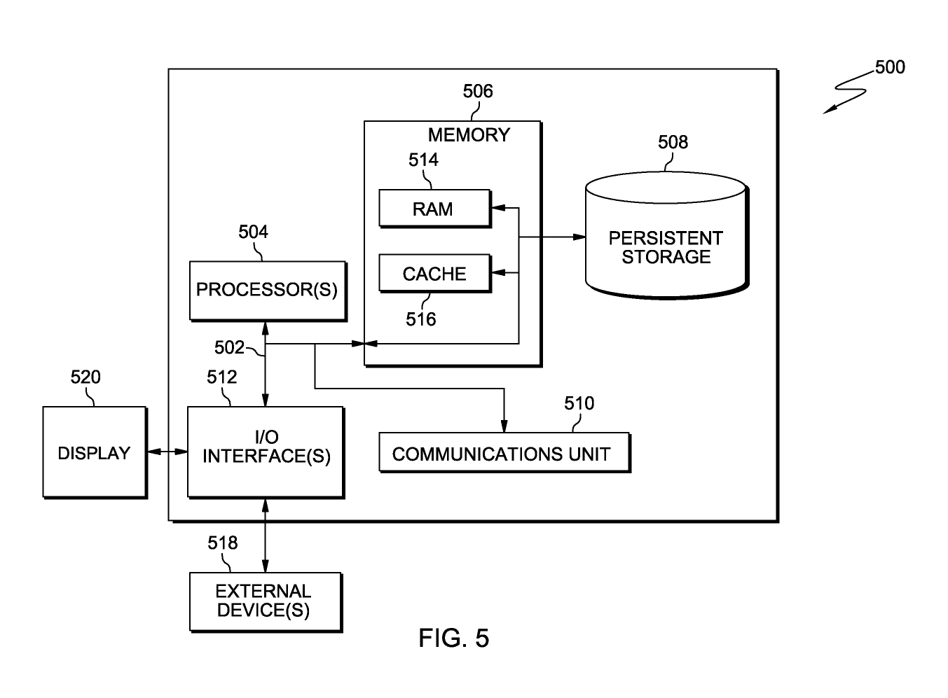

FIG. 5 depicts a block diagram of components of distributed data processing environment 500 which is representative of distributed data processing environment 100, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Distributed data processing environment 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 514 and cache memory 516. In general, memory 506 can include any suitable volatile or non-volatile computer readable storage media.

Receipts 112, user interface 114, product and service locator webpage 122, product and service storage 124, business account 126, transaction product and service program 128, product and service locator application 142, user interface 144, transaction acquisition application 200, product and service generator 300, and product and service search 400 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of an enterprise grid and client devices. In these examples, communications unit 510 includes one or more network interface cards. Communications unit 510 may provide communications through the use of either or both physical and wireless communications links. Receipts 112, user interface 114, product and service locator webpage 122, product and service storage 124, business account 126, transaction product and service program 128, product and service locator application 142, user interface 144, transaction acquisition application 200, product and service generator 300, and product and service search 400 may be downloaded to persistent storage 508 through communications unit 510.

I/O interface(s) 512 allows for input and output of data with other devices that may be connected to distributed data processing environment 500. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., receipts 112, user interface 114, product and service locator webpage 122, product and service storage 124, business account 126, transaction product and service program 128, product and service locator application 142, user interface 144, transaction acquisition application 200, product and service generator 300, and product and service search 400 can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1-7. (canceled)

8. A computer program product for creating a transaction based searchable resource, the computer program comprising:
one or more computer readable storage media and program instructions stored on the one or more computer readable storage media, the program instructions comprising:
program instructions to receive a transaction receipt and a unique identification;
program instructions to identify commodity data associated with the received transaction receipt, wherein the identified commodity data includes one or more commodities with transaction dates and one or more of the following: product descriptions and service descriptions;
program instructions to determine an account within a repository that corresponds to the received unique identification; and
program instructions to store the identified commodity data within the determined account within the repository.

9. The computer program product of claim 8, wherein the transaction receipt comprises one or more of: an electronic receipt for one or more commodities and a manual receipt for one or more commodities stored on the one or more computer readable storage media.

10. The computer program product of claim 8 wherein identifying the commodity data associated with the received transaction receipt comprises program instructions, stored on the one or more computer readable storage media, to:
process the received transaction receipt utilizing one or more of: handwriting recognition software and optical character recognition software;
apply natural language processing to the processed transaction receipt; and
extract at least the identified commodity data from the processed transaction receipt.

11. The computer program product of claim 8, further comprising program instructions, stored on the one or more computer readable storage media, to:
determine whether the identified commodity data from the received transaction receipt matches a stored entry of commodity data for the determined account; and
responsive to determining the identified commodity data from the received transaction receipt matches the stored entry of commodity data for the determined account, update the stored entry of commodity data for the determined account with the commodity data from the received transaction receipt.

12. The computer program product of claim 8, further comprising program instructions, stored on the one or more computer readable storage media, to:
determine whether the identified commodity data from the received transaction receipt matches a stored entry of commodity data for the determined account;
responsive to determining the identified commodity data from the received transaction receipt does not match a stored entry of commodity data for the determined account, create a new entry within the determined account; and
store the identified commodity data from the received transaction receipt within the new entry within the determined account.

13. The computer program product of claim 8, further comprising program instructions, stored on the one or more computer readable storage media, to:
receive search criteria;
determine one or more accounts within the repository that match the received search criteria;
provide a list of the determined one or more accounts within the repository that match the received search criteria;
receive a selected account from the list of determined one or more accounts; and
provide expanded data from an account within the repository that corresponds to the selected account, wherein the expanded data comprises at least matching commodity data based on the received search criteria.

14. The computer program product of claim 13, further comprising program instructions, stored on the one or more computer readable storage media, to:
receive one or more selections to provide feedback on the expanded data;
provide the one or more selections for feedback to be entered upon;
receive feedback and an indication of completion; and
update the one or more selections within the account within the repository for the selected account with the received feedback.

15. A computer system for creating a transaction based searchable resource, the computer system comprising:
one or more computer processors, one or more computer readable storage media, and program instructions stored on the computer readable storage media for execution by at least one of the one or more processors, the program instructions comprising:
program instructions to receive a transaction receipt and a unique identification;
program instructions to identify commodity data associated with the received transaction receipt, wherein the identified commodity data includes one or more commodities with transaction dates and one or more of the following: product descriptions and service descriptions;
program instructions to determine an account within a repository that corresponds to the received unique identification; and
program instructions to store the identified commodity data within the determined account within the repository.

16. The computer system of claim 15 wherein identifying the commodity data associated with the received transaction receipt comprises program instructions, stored on the one or more computer readable storage media, to:
process the received transaction receipt utilizing one or more of: handwriting recognition software and optical character recognition software;
apply natural language processing to the processed transaction receipt; and
extract at least the identified commodity data from the processed transaction receipt.

17. The computer system of claim 15, further comprising program instructions, stored on the one or more computer readable storage media, to:
determine whether the identified commodity data from the received transaction receipt matches a stored entry of commodity data for the determined account; and
responsive to determining the identified commodity data from the received transaction receipt matches the stored entry of commodity data for the determined account, update the stored entry of commodity data for the determined account with the commodity data from the received transaction receipt.

18. The computer system of claim 15, further comprising program instructions, stored on the one or more computer readable storage media, to:
determine whether the identified commodity data from the received transaction receipt matches a stored entry of commodity data for the determined account;
responsive to determining the identified commodity data from the received transaction receipt does not match a stored entry of commodity data for the determined account, create a new entry within the determined account; and
store the identified commodity data from the received transaction receipt within the new entry within the determined account.

19. The computer system of claim 15, further comprising program instructions, stored on the one or more computer readable storage media, to:
receive search criteria;
determine one or more accounts within the repository that match the received search criteria;
provide a list of the determined one or more accounts within the repository that match the received search criteria;
receive a selected account from the list of determined one or more accounts; and
provide expanded data from an account within the repository that corresponds to the selected account, wherein the expanded data comprises at least matching commodity data based on the received search criteria.

20. The computer system of claim 19, further comprising program instructions, stored on the one or more computer readable storage media, to:
receive one or more selections to provide feedback on the expanded data;
provide the one or more selections for feedback to be entered upon;
receive feedback and an indication of completion; and
update the one or more selections within the account within the repository for the selected account with the received feedback.
